(19) United States
(12) Patent Application Publication
(10) Pub. No.: US 2012/0204458 A1
(43) Pub. Date: Aug. 16, 2012

(54) SPACE SAVING MANUAL SHELF MANAGEMENT SYSTEM

(76) Inventor: William R. Goehring, Wexford, PA (US)

(21) Appl. No.: 13/205,874

(22) Filed: Aug. 9, 2011

Related U.S. Application Data
(63) Continuation of application No. PCT/US10/59747, filed on Dec. 9, 2010.
Application No. PCT/US10/59747 is a continuation-in-part of application No. 12/238,847, filed on Sep. 26, 2008, now Pat. No. 7,992,726.
(60) Provisional application No. 61/285,082, filed on Dec. 9, 2009.
(60) Provisional application No. 60/975,632, filed on Sep. 27, 2007.
(60) Provisional application No. 61/032,673, filed on Feb. 29, 2008.

(51) Int. Cl. A47F 5/10; B65D 71/00; B65D 77/04; G09F 3/20

(52) U.S. Cl. 40/642.02; 211/134; 206/223; 206/229

(57) ABSTRACT

A manual open bottom shelf allocation and management system for allocating shelf space among rows of products and for moving the rows of products toward the shelf front includes a plurality of adjacent shelf allocating and managing units. Each unit includes a pair of side dividers extending away from a backstop defining an open bottom, wherein at least one row of products may be positioned on the shelf between and laterally supported by the side dividers. Each unit is manually movable to advance products toward the front of the shelf. The side dividers of two adjacent units may be in vertical alignment with one another. A shelf ready packaging unit incorporates a row of products and a shelf allocation and management system and packaging material coupling the shelf allocating and managing unit and the at least one row of products together at least for shipping and stocking.

### RELATED APPLICATIONS

This application is a Continuation of and claims the benefit of PCT Patent Application serial number PCT/US10/59747 filed Dec. 9, 2010 entitled “Space Saving Manual Shelf Management System” which published as International Application under WO 2011/087647. This publication is incorporated herein by reference.

PCT Patent Application serial number PCT/US10/59747 claims the benefit of U.S. Provisional patent application Ser. No. 61/285,082 filed Dec. 9, 2009 entitled “Manual Shelf Management System”.

This application is a Continuation-in-Part (CIP) of and claims the benefit of U.S. patent application Ser. No. 12/238,847 filed Sep. 26, 2008 entitled “Space Saving Manual Shelf Management System” which published as United States Patent Publication number 2009/0084745, now U.S. Pat. No. 7,992,726. This patent and this publication are incorporated herein by reference.

U.S. patent application Ser. No. 12/238,847 claims the benefit of U.S. Provisional patent application Ser. No. 60/975,632 filed Sep. 27, 2007 entitled “Manual Shelf Management System.” U.S. patent application Ser. No. 12/238,847 claims the benefit of U.S. Provisional patent application Ser. No. 61/032,673 filed Feb. 29, 2008 entitled “Manual Shelf Management System.”

### BACKGROUND OF THE INVENTION

1. Field of the Invention

The present invention relates to manual shelf management systems and shelf ready packaging units, and more specifically to a space saving, manual, open bottom, containing and supporting, shelf management system and a shelf management system that can be incorporated into shelf ready packaging unit.

2. Background Information

In stores, for example grocery stores, that display products on shelves it is necessary to continually move the products from the rear to the front of the shelf so that customers can more readily see and select those items that they desire. The movement of products towards the front of the shelf is called “facing” or “fronting.” It is also essential that the products be arranged laterally (side-to-side) as closely as possible to conserve limited and valuable lateral shelf space, and thereby maximize the products that can be displayed and sold.

Furthermore, if the products are hidden at the rear of the shelf or if an insufficient depth of the shelf is utilized and the product is thereby more readily exhausted, or if the products are in disarray, potential sales are lost. Stocking new products on store shelves historically requires significant time and effort. Products must be individually positioned on the shelves in straight rows, and sometimes product containers are stacked one on top of the other adding to the difficulty for the worker. Stocking becomes a taxing exercise in finesse and physical exertion, especially when stocking low or high shelves. The process of “rotation”, where older items are brought to the front of the shelf and newer items placed in the rear, historically has required that every item in a product row be individually handled and repositioned.

Products are occasionally moved to a different location of the store altogether, called “resetting” of the products. Ordinarily all of these so-called “shelf conditioning” tasks described above require the handling of each individual item (e.g. each soup can). This piece-by-piece handling of items is time-consuming, imprecise, creates fatigue for store personnel and may impede the proper completion of some shelf conditioning tasks.

One method of minimizing stocking time is the use of “shelf ready packaging” in which the product is moved en mass from the shipping container to the store shelf, often being left in the shipping container itself which is placed on the store shelf. The shelf ready packaging technique is more often utilized at “warehouse” or “bulk” stores which typically do not have the same shelf space restrictions as conventional grocery stores or super markets. The conventional shelf ready packaging implementations do not account for laterally compact product spacing or provide for rotation during stocking or for fronting during sales, and thus has had limited application in conventional grocery stores or super markets. In the conventional grocery store or super market the shelf ready packaging has generally been limited to pouches (e.g., pet treats, tuna fish and sauce mixes) and small non-food items (e.g., a display of cigarette lighters) and to specialty non-shelf products (e.g., a broom display).

The prior art has addressed some of these issues relating to shelf management and developed relatively complex shelf management machines to advance rows of products on a shelf. These shelf management devices are generally complex with multiple parts, are expensive, and involve a complicated installation. Further, some of these prior art devices occupy an objectionable amount of lateral shelf space and thereby do not maximize the amount of lateral shelf space available for display.

U.S. Pat. Nos. 1,703,987; 2,652,154; 3,028,014; 3,083,067; 3,110,402; 3,357,597; 4,300,693; 4,724,968; 4,729,481; 4,730,741; 4,762,236; 4,830,201; 4,836,390; 4,901,869; 4,907,707; 5,012,936; 5,069,349; 5,111,942; 5,123,546; 5,240,126; 5,450,969; 5,542,552 5,992,652; 6,105,791; 6,129,218; 6,357,606; 6,382,431; 6,484,891; 6,772,888; 6,886,700; 6,889,854; 7,063,217; 7,086,541 and 7,168,579 disclose complex mechanisms for advancing product rows which, in general, provide a spring-biased backstop which constantly and automatically forces the products from the rear toward the front of the shelf. While these so-called “spring-loaded” devices are generally effective for managing light-weight merchandise (e.g. packages of panty hose) they are generally not effective when used for heavier items (e.g. jars of pasta sauce). They are also complex with combined plastic and metal construction and are relatively costly. Additionally, the constantly biased backstop can increase the difficulty of restocking the shelves, as in all of these arrangements the spring-biased backstop must be pushed back with one hand while the new products are positioned on the shelf. Further, the springs can lose their tension over time rendering the system less effective.

U.S. Pat. Nos. 4,768,659, 4,785,945, 5,160,051 and 5,197,610 disclose shelf management systems that utilize an inclined shelf where products are urged to the front of the shelf by force of gravity. These so-called “gravity fed” systems will not operate with existing flat shelves; rather, the existing shelving is removed and new inclined shelves are installed. A time-consuming and costly installation process is required that involves wholesale removal of existing store shelving and installation of new shelving.

U.S. Pat. No. 6,991,116 discloses a “gravity fed” shelf management system that installs on existing flat supermarket shelving. While effective in merchandising cans, this system is less effective for jars and will not work for boxes or other non-round packages. It also requires special vertical shelf spacing and may occupy an objectionable amount of lateral space. This system is complex and is relatively expensive.

U.S. Pat. No. 4,042,096 discloses a shelf management system having a “pusher” disposed behind the row of products with side members tying the pusher to a pull handle at the front of the shelf and to confine the row of objects laterally in alignment. A rail is disposed at the front of the shelf to prevent objects from falling off the shelf as the pusher is drawn forward by the handle. Resilient means are disposed behind the pusher to return it and the handle to normal position after being drawn forward by a pull on the handle. The system does not present a compact shelf management solution and incorporates a significant number of components including a return spring that is subject to fatigue and failure. The accumulated thicknesses of the side members, which stack laterally against one another, consume too much lateral shelf space and selling space is lost. The system is not adjustable to allow product packages of different widths to be accommodated.

U.S. Pat. No. 2,079,754 discloses a complex arrangement with multiple parts which combines the dispensing of the products with the movement of the products toward the front of the shelf. The side members are arranged in a laterally stacking fashion such that the accumulated thicknesses of the side members combine to consume too much lateral shelf space. Selling space on the shelf is thereby lost. Multiple parts of this complex system include a detached “floating” backstop as well as a separate pulling and article receiving component that is manually operated for product movement and dispensing.

U.S. Pat. No. 2,098,844 discloses a shelf management system that forms a product supporting tray within which the product can be advanced. This is a complex, multi-piece system that requires installation of components both on the top and on the underside of the shelf such that most standard store shelves would have to be replaced with custom-designed shelves to accommodate this system. Further, because the side members of the frames of this system laterally stack against one another, the accumulation of the combined thicknesses of the side members consumes too much lateral shelf area. Lateral selling space on the shelf is lost.

U.S. Pat. No. 6,719,151 and US Published Patent Application Number 2004/0178158 disclose a wire frame shelf management system that provides a manual open bottom shelf management system. The system is designed primarily to fit under the open, concave rounded edges at the base of certain products (e.g. jars of pickles) and fails to provide lateral support for the products. This lack of lateral support can result in products moving to the left or right or even tipping over during advancement creating significant problems during product movement. Further, to use this system for products that do not have rounded edges at the base, such as cans and small boxes, a specially formed tray must be installed to elevate the displayed products to create a space underneath the products within which the system can function. In an alternative embodiment wedge-shaped dividers are provided which offer limited lateral support; however, in this embodiment, if the system is filled with products that do not have rounded edges at the base, the wedge-shaped dividers will either laterally stack side-to-side causing the accumulated thicknesses of these dividers to consume objectionable lateral selling space, or the wedge shape of the dividers will not conform to the outside edges of the product creating wasted lateral space. The rear element or backstop of this system is not adjustable in width to accommodate products of varying widths. In its preferred embodiment this system fails to provide lateral product support. In a further embodiment the system requires an additional tray apparatus to function which requires an added installation step and added cost. In a still further embodiment the system employs wedge-shaped dividers that stack side-to-side thereby consuming valuable lateral selling space.

U.S. Pat. No. 7,124,897 discloses an assembly deployed on a complex multi-piece platform and features a base divided into rows with dividers. For each row there is a manually-operated pusher mechanism in the form of a rectangular wire device with a front handle and a rear portion that is bent upwards to form a back-stop. The sides of the wire device ride in grooves positioned along either side of the base on which the products rest. This system is complex with multiple parts and would be relatively costly to produce. Neither the divider spacing nor the width of the pusher mechanism is adjustable; therefore this system cannot be adapted to accommodate products that differ in width from those for which the system was originally designed. In an alternative embodiment merchandise rides on a base with integral ball bearings or rollers, in either case a complicated and costly feature.

U.S. Pat. Nos. D472,411; 1,702,987; 1,708,407; 1,910,046; 2,980,259; 5,411,146; 5,413,229; 5,469,976; 5,638,963; 6,082,556; 6,155,438; 6,227,386; 6,527,127; 6,823,997; and 6,923,330 disclose a variety of shelf management systems that are representative of the art. All of these systems use complex designs with multiple pieces. All are relatively costly, and all require involved installation.

Publication U.S. 2005/0258113 A1 discloses, in one embodiment, a puller member where the puller runs along the side of the product row and is attached to a backstop designed to rest behind the rear-most product in the row. In one embodiment the puller and backstop operates within the confines of a sleeve where the sleeve provides product row separation and provides product lateral support. In one embodiment the sleeve is combined with the puller and backstop and is filled with products to form a shelf ready package. In an additional embodiment the puller and backstop operates between two adjustable side dividers where the dividers provide product row separation and product lateral support. In all embodiments the puller and backstop does not operate as a divider independently nor does the puller and backstop provide lateral support independently. The backstop on the puller is of a fixed length and is not adjustable to accommodate products of varying widths. The backstop is not curved and is therefore more prone to bending backwards when the puller is actuated.

U.S. Pat. No. 6,588,594 discloses a representative shelf ready package design incorporating a base with sides and an open front that is filled with products and that further incorporates an enveloping wrap or membrane that couples the base and the products together. This shelf ready package is designed to function as a product shipping container that, upon arrival at the store, can be easily unwrapped and then placed directly on the shelf without the products having to be individually removed from the container and placed on the shelf thereby saving labor. This representative design does not provide a mechanism for bringing the products forward once the products towards the front are depleted by shoppers, nor does this design present a compact display system as the sides of the base or platform would stack laterally and would accumulate to occupy an objectionable amount of lateral shelf space when two or more of these units were placed immediately adjacent one another.

U.S. Pat. No. 6,375,015 discloses a system of product containing trays that are of a fixed, pre-determined width. The trays define the product rows and provide product row separation. The trays can be moved forward to facilitate stocking. An integral spring, which adds cost and increases complexity of the system, is attached to the trays and urges them back to the selling position after stocking. A puller member that is attached to a backstop operates within the individual trays. The puller slides underneath the products and therefore itself provides no product row separation and no product lateral support. The puller and backstop are of a fixed width and are not adjustable to accommodate products of different widths.

U.S. Pat. No. 5,613,621 discloses a system of product row divider panels where a drawbar puller with attached backstop is integral to each divider panel and the drawbar moves in a channel forward and backward along the length of the divider panel. The divider panels are stationary with respect to movement between the front and back of the shelf, although the divider panels can be adjusted laterally to positions relative to adjacent divider panels to fit products of varying widths. The drawbar does not, independent of the divider panel, separate the product rows nor does the drawbar provide lateral support to the products independently of the divider panel. The drawbar backstop is not adjustable in width to accommodate products of different widths. The system operates within a modular frame which obliges the store to adopt the system in increments of more than one product row which reduces its flexibility and requires a time consuming installation process.

U.S. Pat. No. 4,840,439 discloses a display cabinet with integral shelves where the shelves incorporate a sliding frame element which encircles the products positioned on the shelves. When the sliding frame is pulled forward it gathers the products and brings them forward to the front shelf edge. Rather than separating products into individual front-to-back rows, the sliding frame element surrounds the entire group of products situated on the full width of the shelf where the group of products may be, for example, five products wide and five products deep. No substantive lateral support of the products is provided by the sliding frame.

The above identified patents are representative of the art and these references are incorporated herein by reference in their entirety. It is the object of the present invention to address the deficiencies of the prior art shelf management systems and provide a highly effective, very low-cost, easy to install and easy to use shelf management system.

### SUMMARY OF THE INVENTION

One aspect of the present invention provides a manual open bottom shelf allocation and management system for allocating shelf space among rows of products and for moving the rows of products toward the front of the shelf. The system comprises a plurality of adjacent shelf allocating and managing units, each unit associated with at least one row of products and freely moveable as a unit relative to the shelf. Each unit of the system includes a backstop positioned generally near the rear edge of the shelf and behind the at least one row of products associated with the unit; and a pair of side dividers extending away from the backstop defining an open bottom adjacent the shelf, wherein the at least one row of products associated with the unit may be positioned on the shelf between the side dividers, and wherein the backstop and side dividers of each unit are manually movable as an integrated unit in a direction extending between the front and the back of the shelf substantially perpendicular to the lateral length of the shelf whereby movement of each unit is adapted to advance the at least one row of products associated with the unit toward the front of the shelf, and wherein the side dividers provide for substantive lateral support for the products adjacent the dividers, at least when a side divider is coupled with a side divider of an adjacent unit.

In one aspect of the present invention the side dividers of two immediately adjacent units are in vertical alignment with one another such that the space between the side dividers of adjacent units which accommodate the rows of products associated with that unit is separated by a distance equal to the thickness of only one side divider. In a further non-limiting embodiment of the present invention the side dividers of a unit are of substantially different lengths relative to one another. In a further non-limiting embodiment of the present invention each unit is associated with a plurality of rows of products. In a further non-limiting embodiment of the invention the width of the rows is variable. The present invention provides for two distinct classes of shelf allocation and managing units, namely a “hoop” class of shelf management units which include a front connecting the sides, and a “cantilevered” class with no front where the sides are cantilevered from the back stop.

A further aspect of the invention provides a shelf ready packaging unit comprising at least one row of products, an open bottom shelf allocating and managing unit, such as in accordance with other aspects of the present invention, associated with the at least one row of products for moving the rows of products toward the front of the shelf after the row of products has been placed upon a shelf; and packaging material, such as a supporting tray and surrounding plastic wrap, coupling the shelf allocating and managing unit and the at least one row of products together at least for shipping and stocking.

These and other advantages of the present invention will be clarified in the description of the preferred embodiments.

### BRIEF DESCRIPTION OF THE DRAWINGS

FIGS. 1A and B are perspective views of manual open bottom shelf allocation and management systems according to two embodiments of the present invention;

FIGS. 2A-D are perspective views of shelf ready packaging according to different embodiments of the present invention with each shelf reading packaging incorporating a manual open bottom shelf allocation and management system according to the present invention;

FIG. 3A is a perspective view of a shelf allocating and managing unit of the manual open bottom shelf allocation and management system of FIG. 1B;

FIG. 3B is a top view of the shelf allocating and managing unit of FIG. 3A;

FIG. 4 is a front view of the shelf allocating and managing unit of FIG. 3A;

FIG. 5 is a side view of the shelf allocating and managing unit of FIG. 3A;

FIG. 6 is a back view of the shelf allocating and managing unit of FIG. 3A;

FIG. 7 is a section view of the front end of the shelf allocating and managing unit of FIG. 3A;

FIG. 8 is a perspective view of an optional locking front-stop shelf attachment for use with the shelf allocation and management system of FIG. 1B;

FIG. 9 is a side view of the optional locking front-stop shelf attachment of FIG. 8 engaged with the shelf allocating and managing unit of FIG. 3A modified to receive the locking front-stop attachment;

FIG. 10 is a perspective view of the optional label holder that can be attached to the front of the shelf allocating and managing unit of FIG. 3A;

FIG. 11 is a view of the optional interlocking channel and ridge modification of the shelf allocating and managing system of FIG. 3A;

FIG. 12 is a front view of an optional latch for the shelf allocating and managing unit of FIG. 3A;

FIG. 13 is a perspective view of the underside of the front end of the shelf allocating and managing unit of FIG. 3A showing optional downward-pointing magnets;

FIG. 14 is a perspective view of an alternative, adjustable shelf allocating and managing unit of the shelf allocation and management unit of FIG. 3A;

FIGS. 15A and B are perspective views of alternative shelf allocating and management units of FIG. 3A that accommodates multiple product rows;

FIG. 16 is a perspective view of an optional adjustable backstop for the shelf allocating and management unit of FIG. 3A;

FIG. 17 is a perspective view of an optional platform attachment for the shelf allocating and management unit of FIG. 3A;

FIG. 18 is a perspective view of a modified version of the shelf allocating and management unit of FIG. 3A that is width-adjustable and has modified dividers that stack together laterally;

FIG. 19 is a perspective view of a modified version of the shelf allocating and management unit of FIG. 3A with modified dividers that stack together laterally in which two or more product rows may be positioned;

FIG. 20 is a perspective view of a product resetting tool for use with the shelf allocation and management system of FIGS. 1A and 1B;

FIG. 21 is a view of a manual open bottom shelf allocation and management unit according to one aspect of the present invention;

FIG. 22 is a side view of the manual open bottom shelf allocation and management unit of FIG. 21;

FIG. 23 is a view of an optional embodiment of the manual open bottom shelf allocation and management unit of FIG. 21 where the side dividers are of substantially different lengths;

FIG. 24 is a view of a further embodiment of the manual open bottom shelf allocation and management unit of FIG. 23 showing a unit that is adjustable in width;

FIG. 25 is an alternative view of the open bottom shelf allocation and management unit of FIG. 24 showing the relation of the unit to an immediately adjacent unit;

FIG. 26 is a direct front view of the open bottom shelf allocation and management unit of FIG. 25 showing the relation of the unit to an immediately adjacent unit;

FIG. 27 is a direct rear view of the open bottom shelf allocation and management unit of FIG. 24 showing one embodiment of a mechanism that allows the unit to be adjusted in width;

FIG. 28 is a view of an embodiment of the manual open bottom shelf allocation and management unit of FIG. 24 further including a backstop that can selectively decrease the number of products associated with one full row within a unit;

FIG. 29 is a view of a further embodiment of the manual open bottom shelf allocation and management unit of FIG. 24 showing a unit with a slideably attached base;

FIG. 30 is a view of a further embodiment of the manual open bottom shelf allocation and management unit of FIG. 24 showing a unit with a removably attached label holder;

FIG. 31 is a view of a further embodiment of the manual open bottom shelf allocation and management unit of FIG. 24 modified to receive an arresting member and showing the arresting member itself;

FIG. 32 is an alternate view of a the manual shelf allocation and management unit of FIG. 31 showing the cut-out or notch at the bottom front of the unit that receives the arresting member;

FIG. 33 is view of an embodiment of a manual open bottom shelf allocation and management unit where the dividers are positioned so that, when two units are placed side-by-side, the divider of one unit is not in vertical alignment with the divider of an immediately adjacent unit;

FIG. 34 is a view of a manual shelf allocation and management unit of FIG. 33 further including a slideably attached base that provides bottom support for the products;

FIG. 35 is a view of a manual shelf allocation and management unit further including a width-adjustable rear and a width-adjustable front where the width-adjustable front lies flat on the shelf allowing a product to be placed directly on top of it; and

FIG. 36 is a view of a back stop extension according to the present invention.

### DESCRIPTION OF THE PREFERRED EMBODIMENTS

It is noted that, as used in this specification and the appended claims, the singular forms “a,” “an,” and “the” include plural referents unless expressly and unequivocally limited to one referent. For the purposes of this specification, unless otherwise indicated, all numbers expressing parameters used in the specification and claims are to be understood as being modified in all instances by the term “about.” The terms “about” or “approximate” or similar terms within this application will generally mean within 10% unless otherwise noted. Accordingly, unless indicated to the contrary, the numerical parameters set forth in the following specification and attached claims are approximations that may vary depending upon the desired properties sought to be obtained by the present invention. The various embodiments and examples of the present invention as presented herein are understood to be illustrative of the present invention and not restrictive thereof and are non-limiting with respect to the scope of the invention.

The present invention provides a manual open bottom shelf allocation and management system 10 for allocating shelf space along a conventional shelf 12 among rows of products 14 and for moving the rows of products 14 from the rear or back of the shelf 12 toward the front edge (or front) of the shelf 12. The direction of movement is standard in shelf management systems and is generally perpendicular to the lateral length of the shelf 12. The term manual within this application and in connection with the system 10 references that only manual movement is used in the system, as opposed to spring assisted systems or gravity assisted systems. As further described below, aspects of the present invention can be used in non-manual systems.

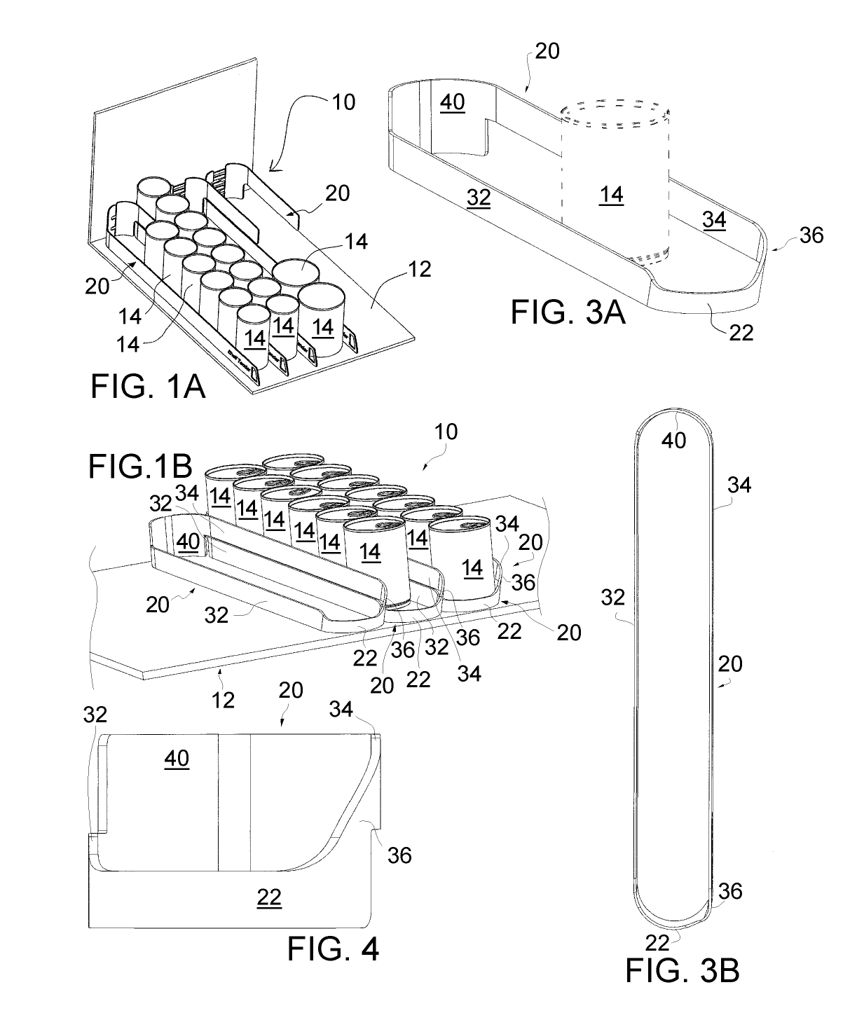

The system 10 includes a plurality of adjacent shelf allocating and managing units (also called managing units or shelf tenders) 20 best shown in FIGS. 1A and 1B. Each managing unit 20 may be, in certain embodiments, a one piece managing unit 20 and can be formed easily as a one piece molded construction, such as by injection molding. It may also be desirable for the managing unit 20 to be formed as an assembly for the purpose of making the managing unit 20 adjustable and possibly also to facilitate manufacturing and shipping.

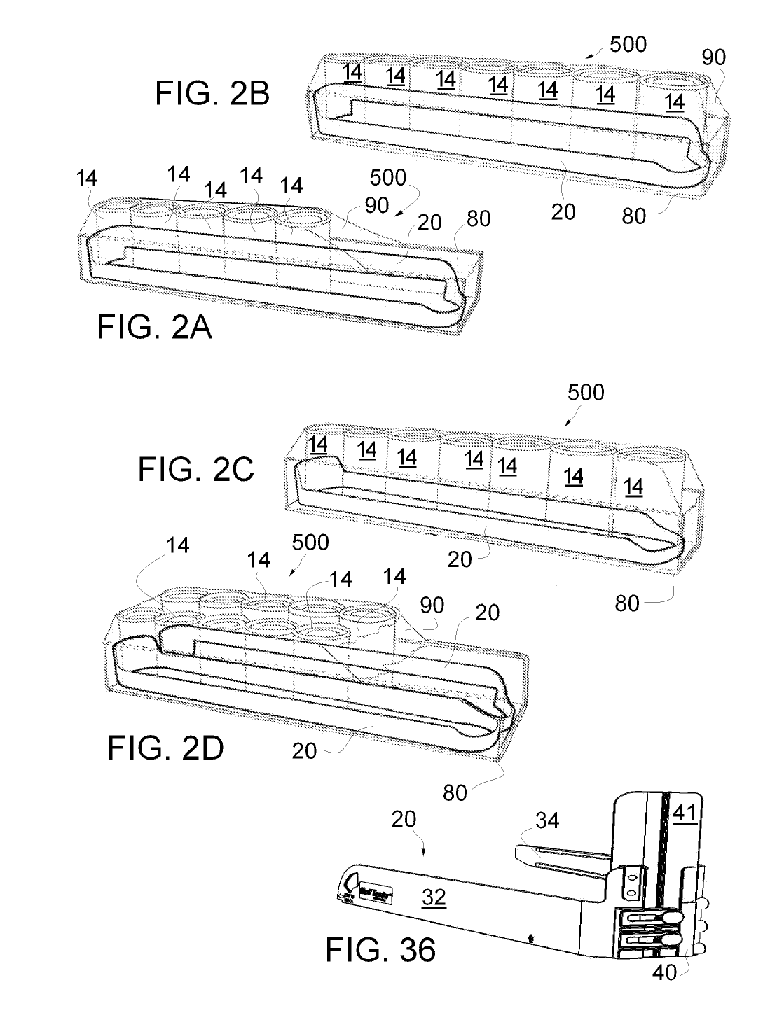

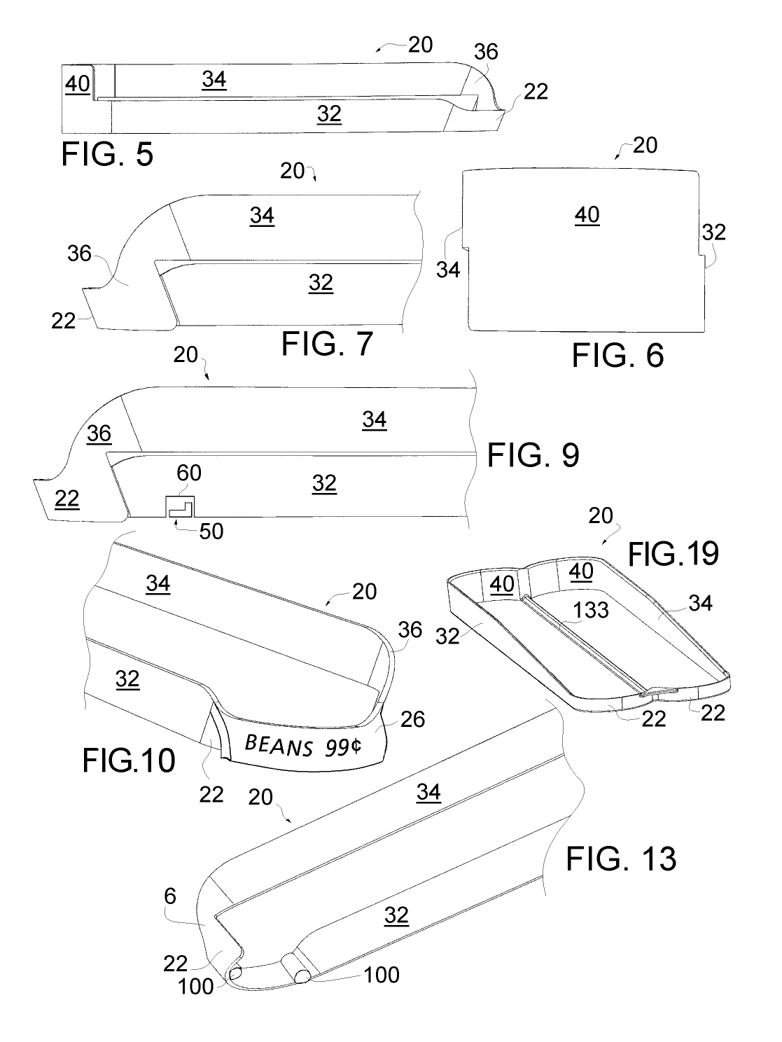

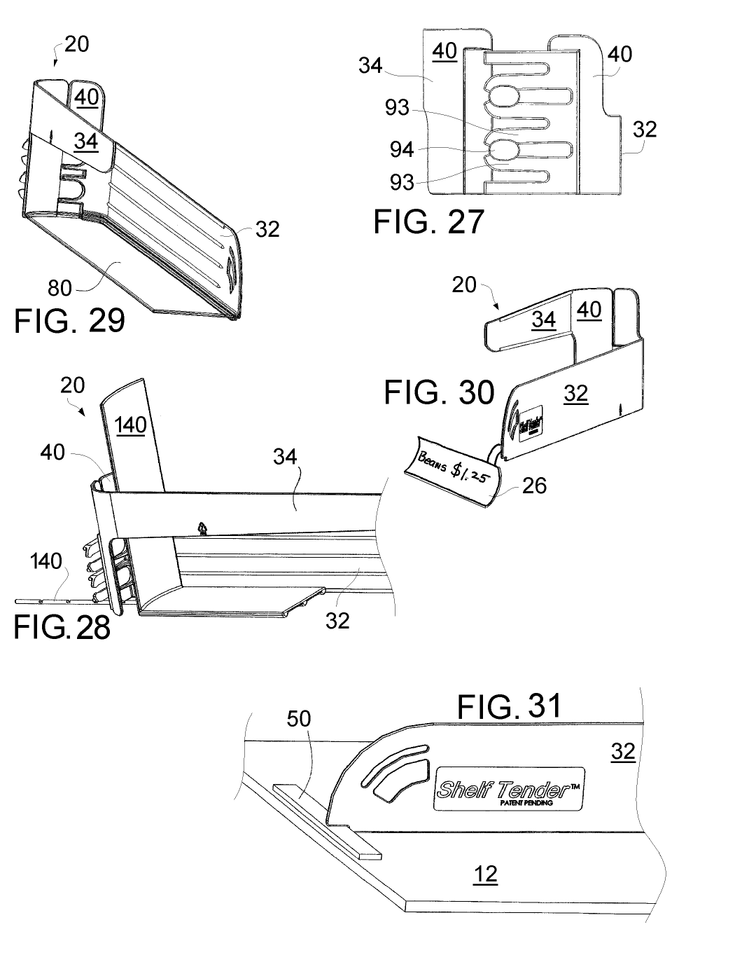

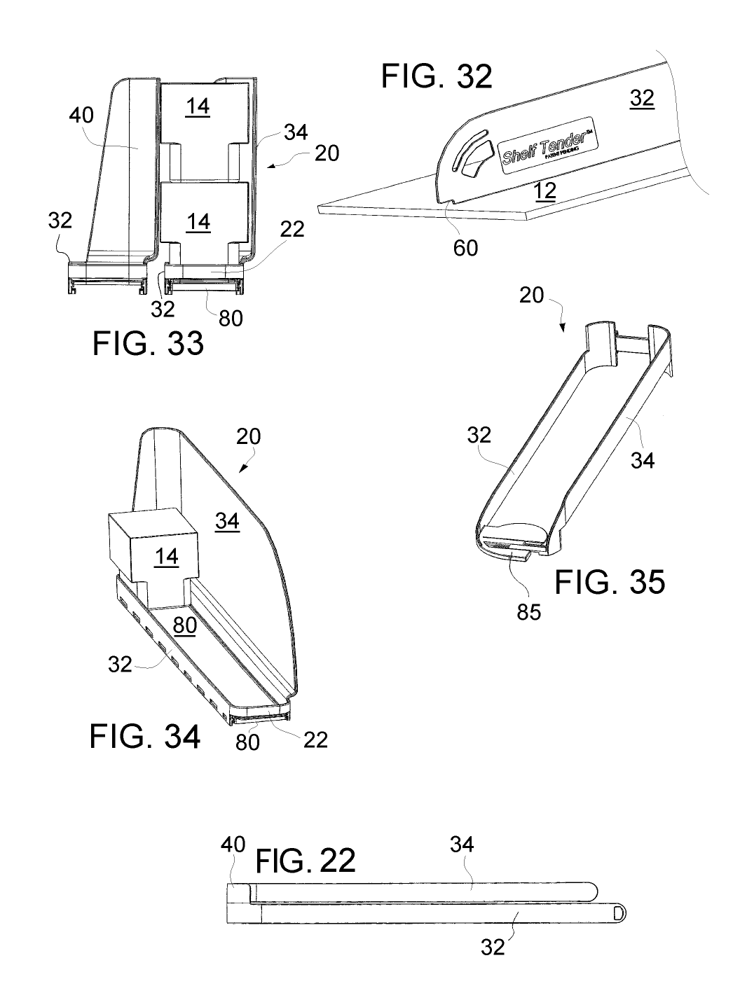

The figures evidence that there is a large number of variations of the shelf management system 10 according to the various embodiments of the present invention. One of the most significant distinctions is the provision (See FIGS. 1B, 2A-D, 3A-B, 4-7, 9-19, and 33-35) or omission (See FIGS. 1A, and 21-32) of a front 22 with each managing unit 20. The provision of the front 22 allows the managing unit 20 to be formed as a hoop surrounding the products 14 with certain advantages in structural integrity in the design of the shelf tender 20. The omission of the front 22 avoids the omitted front from interfering with consumer access to the products 14, but such omission must be accounted for in structural integrity of the managing unit 20 (this class of managing units 20 can be called “cantilevered” managing units 20 herein due to sides 32 and 34 being attached only to the back—although both of the sides 32 and 34 are not truly “cantilevered” in the structural sense, it is helpful as a designation). The differences in the forces transferred among the distinct elements of the managing unit 20 between the hoop shelf tenders and the cantilevered shelf tenders 20 make these two embodiments significantly different from a design perspective. This is thus the most important difference among the disclosed embodiments. Other variances disclosed herein, such as vertically aligned side dividers verses laterally adjacent stacking side dividers, or width adjustable side dividers or other variances also change the functionality of the specific managing units 20 as will be clear in the following description and associated figures.

Turning to the hoop tender 20 embodiment of FIGS. 1B, 2A-D, 3A-B, 4-7, 9-19, and 33-35 each of these managing units 20 includes a front 22 which is a relatively low profile structure such that interference between the front 22 and the products 14 will be minimized when customers are removing products 14 from the associated row on shelf 12. As illustrated in FIG. 35 the low profile of the front 22 can be accentuated by “laying down” this element along the shelf 12. In more precise language the structural integrity of the front 22 can be provided with material in the direction of the shelf 12 rather than primarily in a vertical direction to help minimize the height of the front 22. Further the front 22 may be angled and fashioned in the shape of a ramp to allow product 14 being grabbed by a purchaser and being pulled forward to ride up the ramp-shaped front 22 and not knock the managing unit 20 and associated remaining row of products 14 inadvertently forward. The front 22 may be modified to receive an identification label for the products 14 that are associated with the unit 20.

Each managing unit 20 includes a lower side divider 32 and an upper side divider 34 that together form a pair of side dividers extending away from the front 22 and generally extending the effective depth of the shelf 12. The length of the dividers 32 and 34 (and of the associated managing unit 20) will be, preferably, governed by the depth of the shelf 12 to maximize usable shelf space. Lengths of 10″-40″ for units 20 are possible, with 14″-26″ lengths for unit 20 covering the vast majority of retail shelving 12.

Manufacturing of each managing unit 20 as a single injection molded piece may allow for the lowest manufacturing cost/unit for a plastic unit, however cardboard construction is a viable cost effective alternative for disposable units 20 used in the shelf ready packaging 500 discussed below.

As an alternative to one piece plastic, the managing unit 20 can be assembled by joining together separate plastic components such as front 22, a separate back-stop 40, a separate divider 32 and a separate divider 34. These separate plastic components may be manufactured in varying lengths so that shelves 12 of different depths could be accommodated with the corresponding correct length of dividers 32 and 34, and further that products 14 of different widths could be accommodated with the correct lengths of front 22 and back-stop 40 that correspond to the width of the product 14. Further, with separate components forming the units 20, products 14 that may be tall or stacked one atop the other could be adequately supported with backstops 40 and dividers 32 and 34 of different heights than found in other units 20. These component pieces could be manufactured either through injection molding or extrusion and could be scored so that each section could be shortened (possibly by snapping off) in increments of possibly 0.5″ for the dividers 32 and 34 and increments of possibly 0.10″ for the front 22 and back-stop 40.

In a further alternative, the front 22, and dividers 32 and 34 could be manufactured as a single piece and backstops 40, in various heights, could be attached to complete a managing unit 20.

The front 22 in the managing unit 20 is coupled to upper divider 34 through post 36. Beginning at the front end of divider 34, post 36 simultaneously curves laterally inward and vertically downward to connect with front 22. Post 36 allows upper divider 34 to be positioned in such a way that the bottom edge of upper divider 34 is maintained at a vertical point above the top edge of lower divider 32 of the same (and adjacent) managing unit 20 at all points along its length. In this way, when two managing units 20 are placed together side-by-side, the divider 34 of one unit rides over divider 32 of the adjoining or adjacent unit without touching divider 32 at any point, and when two managing units 20 are placed together side-by-side a single-thickness divider along the lateral dimension of the shelf 12 is presented along the entire length of dividers 32 and 34. On the vertical dimension, the divider 34 of one unit “stacks” on top of (but does not touch or interfere with) the divider 32 of the adjoining or adjacent managing unit 20 thereby presenting a higher combined divider (32+34) that provides substantial lateral support for the products 14 associated with the respective managing units 20. The lateral support is not diminished if there is a gap between the dividers 32 and 34.

The combined dividers 32 and 34 (or individual dividers 32 or 34 in the case of the end managing unit 20 of a system 10) provide lateral support of the products 14. Lateral support of the products 14 is useful in that it confines the product row(s) associated with a given managing unit 20 and maintains the row in a more or less straight line both when new products 14 are placed on the shelf 12, as when occurs when stocking, and when the product row is pushed forward by the backstop 40, as occurs when the front 22 is pulled forward, as occurs when facing or fronting a product row associated with a managing unit 20. Lateral support also discourages the products 14 from tipping to the side. Further, lateral support prevents products in one row associated with a managing unit 20 from co-mingling with (different) products in adjoining rows. Effective lateral support of the product 14 can be achieved with a divider that is substantially lower than the top of the product 14, or, if the products 14 are stacked one-on-another, the top of the product 14 stack.

Due to the symmetrical nature of many products 14 and the low-friction nature of the surface of the shelf 12 the dividers can be of relatively low height and still provide substantial lateral product support. In order to provide some quantitative guidelines, substantive lateral support within the meaning of this application will mean a sidewall height of at least 15% of the height of the product or product stack height. If the product or product stack is relatively stable then substantive lateral support would mean approximately 15-50% of the height; conversely if the product or product stack has low stability, then substantive lateral support would mean approximately 20-90% of the height. The “sidewall height” within the meaning of this application is the combined height of the dividers 32 and 34, including any gap there between, measured when two managing units 20 are placed together side-by-side.

The dividers 32 and 34 are defined by three dimensions: the thickness of the divider, the length of the divider (corresponding roughly to the shelf depth) and the planar height of the divider. To illustrate, although the top edge of divider 34 may be 4″ above the shelf, the planar height of the divider 34 may be only 1″. The divider 34 is in all embodiments, other than the embodiments of FIGS. 18 and 19 and FIG. 2C, suspended above the shelf 12 so its planar height will always be smaller than the distance from the shelf surface to the top edge of divider 34.

The dividers 32 and 34 may, in an alternative embodiment, not be balanced with the planar height of divider 32 being taller than the planar height of divider 34 or the planar height of divider 34 being taller than the planar height of divider 32 while, in all cases, the lower edge of divider 34 is at all points along its length above the upper edge of divider 32 so that neither divider 32 or 34 interferes with the movement of the adjacent divider 34 or 32 in use. The higher that the lower end of divider 34 is relative to the shelf 12 the higher and more extensive is the design of the post 36. Consequently for products 14 that benefit from a relatively high sidewall structure (combined divider height), it may be more preferable to minimize the height of the lower divider 32 and maximize the height of the higher divider 34, which, in turn, minimizes the construction of the post 36. In the illustrated embodiments of the present invention having vertically aligned dividers 32 and 34, the side dividers of each unit provide substantial lateral support to the products, at least when a side divider is coupled with a side divider of an adjacent unit. In many implementations the side dividers 32 and 34 are of substantive height to provide substantive lateral support individually, however, even if one divider, e.g., divider 32, is of minimal height wherein it does not, individually, provide substantive lateral support to the products, this support will be provided with the combined, aligned dividers.

Having both dividers 32 and 34 with front 22 allows the managing unit 20 to form a loop around the products 14 for advancing them. Without a front 22 a cantilever structure would result as in the embodiments of 1A, and 21-32, which represent a distinct operating principle for the managing unit 20. In a further modification there may be an increased gap between the lower edge of divider 34 and the upper edge of divider 32. In a still further modification each divider 32 and/or divider 34 and/or backstop 40 and/or front 22 may include openings therein for viewing of the products 14 and/or for stylized purposes and/or to reduce the amount of plastic required for manufacture of the managing unit 20; and/or to facilitate air flow around the products 14 such as in the case where products 14 require refrigeration.

The lower divider 32 being positioned on the left or right side of the unit 20 and the upper divider 34 being positioned on either side of the managing unit 20 is unimportant provided that within an installation 10 of managing units 20, the lower dividers 32 are all on the same side and the upper dividers 34 are all on the opposite side in any series of managing units 20. Within the illustrated embodiments of this application the lower divider 32 is on the left and the upper divider 34 is on the right solely for the purpose of consistency in illustration.

For the hoop shelf tenders 20, one embodiment may provide that extra weight may be added to the rear side of the back-stop 40 of a managing unit 20 on the same side as the lower divider 32 as a counterweight mechanism. This extra weight may be added in such quantity to reduce or eliminate the tendency of the hoop shelf tender 20 to tip to the side in the direction of the upper divider 34 especially when the managing unit 20 is pulled forward far enough that the front 22 of the managing unit 20 hangs beyond the front edge of the shelf. A magnet may also be used to form the counterweight and provide some additional holding or stabilizing force to keep the proper orientation for the hoop shelf tender 20 relative to a metal shelf 12; however such an option may not be cost effective in the overall system 10.

Where a managing unit 20 may be used to merchandise products that are stacked two-high, three-high or four-high (e.g., tuna cans and cat food cans), the top of the upper divider 34 may be approximately the same height as the top of the product stack (for example, in the case of baby food jars stacked 3-high, the top may be about 7″ high) so that this stacked merchandise can be more securely contained within the managing unit 20. Individual pieces of merchandise or product 14 are less apt to fall to one side or the other.

In order to reduce the degree to which these higher dividers might obstruct the side view (of a store customer) of the product or product stack, the front of the upper divider 34 may be swept back at an angle so that towards the front section of the upper divider 34 the top of the upper divider 34 may be, for example, 2″ high and would attain increasingly greater height as it extended rearward and would reach its full height (7″ in this example) at a point, for purpose of illustration, 8″ rearward of the front 22 of a managing unit 20.

The dividers 32 and 34, front 20, and/or possibly even the backstop 40 provide convenient places for branding of the managing unit 20. The branding of the managing unit 20 may be with the store logo, or may be associated with the product 14. It is expected that the managing units 20 may be supplied by the manufacturers of the specific products 14 to allow retailers of the products 14 to better display, promote and manage that particular product 14. Where the manufacturers of the products 14 are supplying to a store the managing units 20 of a system 10 there is no difficulty in matching the width of the managing unit 20 to the width of the product 14 associated with each managing unit 20. The manufacturers can use the offer of a low-cost, or free, system 10 to encourage a retailer to stock a particular line of products 14 from the manufacturer and/or to obtain a desired shelf placement. The decrease in stocking, facing (bringing products to the front of the shelf 12), rotating and product resetting times will be advantageous to the retailer, while the improved product presentation and increased sales from having properly positioned products 14 will inure to the benefit of both the manufacturer and the retailer. Further, these advantages may lead to an increase in the facings for products, i.e. the amount of lateral shelf space available for products, associated with the managing units 20 that the retailer provides to this manufacturer, which will further increase the benefits to the retailer and the manufacturer.

The manufacturer may supply the managing units 20 as part of shelf ready packaging units 500 as shown in FIGS. 2A-2D. The shelf ready packaging units 500 include a number of products 14 in a shelf allocation and management unit 20 according to one embodiment of the invention together with packaging material that couples the unit 20 and products 14 together sufficiently for shipping and stocking. In the illustrated embodiment the packaging material is formed by a resetting tool 80 (described in greater detail below), and surrounding shrink wrap 90. The resetting tool 80 here may primarily be cardboard packaging that protects the products 14 of the shelf ready packaging unit 500 during shipping and supplies a support tray for the products 14 during shipping and stocking. An alternative packaging material formation is the cardboard resetting tool 80 together with additional cardboard members integral with the resetting tool 80 to form a substantially encircling and enveloping box around the unit 500, with score lines or tear strips built in to remove the non-illustrated parts and leave the resetting tool as a support tray for stocking purposes.

The number of products 14 for the units 500 could completely fill the managing unit 20 as shown in 2B and 2C or may include openings as shown in FIGS. 2A and 2D which easily accommodates product rotation. The shelf ready packaging units 500 allow the users to (i) remove the wrap 90 (or other portions of the box in the alternative described above), and then (ii) optionally rotate the older products 14 to the front of the row within the managing unit 20 for embodiments 2A and 2D by placing the older products 14 in the open spaces, and then (iii) slide the products 14 onto the shelf 12 using the shelf tender 20. The managing unit 20 allows the stores to front the products 14 during the offering and selling/removal of the products 14 in the shelf ready packaging unit 500.

The shelf ready packaging applications can allow the units 20 to be designed with a shorter working life as the units 20 are replaced when the product 14 in the shelf ready packaging unit 500 are sufficiently depleted by shoppers and a new shelf ready packaging unit 500 is placed on the shelf 12. In general these “disposable” managing units 20 will be used for an initial shelving or stocking operation and a limited number of fronting operations (possibly, rarely, a resetting operation) before replacement. Thus cardboard construction for the managing units 20 may be appropriate for these disposable embodiments. Additionally, where plastic is used for manufacturing the disposable managing units 20 of the shelf ready packaging units 500, there are less durability concerns and less plastic can be utilized. The “disposable” managing units 20 are likely to be significantly less expensive to manufacture than managing units 20 that are effectively semi-permanent store fixtures.

Further, the branding on dividers 32 and 34 (and/or front 20 and/or backstop 40) may offer particular advantages with the “disposable” shelf tenders 20 of the shelf ready packaging units 500, wherein the branding is expected to be rotated quickly. The expected “quick” rotation or replacement of the disposable shelf tenders 20 allows for timely or seasonal branding to be easily accomplished (e.g. branding specific to Valentine's day, the NFL® Superbowl, Christmas, 4^{th} of July, limited time promotions, etc)

Where the system 10 is purchased by the store itself then a variety of sizes of managing units 20 would be selected so the retailer can accommodate the variety of products 14 sold in the store, or adjustable managing units 20 would be purchased so the store personnel could adjust the width (and possibly the length) of the managing units 20 to accommodate various widths of products 14 and various shelf depths. The decrease in stocking, facing (bringing products to the front of the shelf 12), rotating and product resetting times will be advantageous to the retailer. The decrease in these times should yield an increase in sales as products 14 can more easily and rapidly be presented to the customer. Further, with the retailer purchased systems the retailer can determine which particular products 14 should be utilized with the system 10 to maximize the improvements for the store.

The design of the managing unit 20 incorporating a divider 34 that is, along its entire length, positioned above divider 32 allows for a minimal lateral distance between the rows of products 14, namely only the thickness of a single divider 32 or 34. When an array of managing units 20 are placed together to form a system 10, the divider 32 of one managing unit 20 is positioned directly under the divider 34 of an adjoining managing unit 20 positioned to the left, and the divider 34 is positioned directly over divider 32 of an adjoining managing unit 20 positioned to the right such that a combination of dividers 32 and 34 form a single divider 32 or 34 thickness. The dividers 32 and 34 of these embodiments of the present invention do not stack one against the other side-to-side (laterally, as contrasted with the laterally stacking side dividers 32 and 34 embodiments of FIGS. 18 and 19 and 2C); rather the dividers 32 and 34 ride over and under each other (preferably without significant contact). Critical lateral shelf space is thereby preserved as only a single divider thickness 32 or 34 separates one row of products 14 from the next row of products 14.

The thickness of the dividers 32 and 34 will vary depending upon the material used. However for an injection molded plastic managing unit 20 the thickness of the divider 32 or 34 will be approximately 1/10″ or less. The disposable cardboard managing units 20 would have similar dimensions which are sufficient for their use. The thickness of the dividers 32 and 34 is substantially equal, and generally only as thick as necessary to provide an adequate side divider and to couple the managing unit 20 together and to maintain structural integrity of the managing unit 20. An unequal thickness in the dividers 32 and 34 would needlessly increase the effective width of the system 10. If the dividers of a shelf management system were to occupy even a minimal extra width of, for example, ⅛″, selling space would be lost over the lateral length of the shelf 12 as these divider thicknesses accumulated. If a shelf management system results in too much lost product selling space then the advantages of such a system could be overshadowed by the lost product selling space, and the system might be frowned upon by the retailers.

The front 22, dividers 32 and 34 and backstop 40 define an open bottom, whereby at least one, and often only one, row of products 14 is positioned between the side dividers 32 and 34 on the shelf 12. Especially in the case of interlocking cans and interlocking jars, the products 14 may be stacked one on top of the other. Each hoop shelf tender 20 is manually movable between the front and the back of the shelf 12 via the operator grasping the front 22 (or grasping the optional label holder 26) and pulling forward to advance the row of products 14 from the rear towards the front of the shelf 12. When the managing unit 20 is drawn forward the backstop 40 engages the rearmost item (or stack of items) in the row of products 14 and moves the products 14 towards the front of the shelf 12. As the rearmost product 14 is moved forward it contacts and pushes forward the next product in the row and so on until all of the products 14 in the row are moved forward. The backstop 40 is pulled forward on both sides by the dividers 32 and 34 of the hoop shelf tender 20. With the products 14 advanced towards the front of the shelf 12 the unit 20 is slid back to the starting position with the front 22 positioned approximately at the front edge of the shelf 12.

The system 10 may be used with effectively any shelf 12 with the length of the dividers 32 and 34 being associated with the shelf depth as noted above. The shelf 12 may have an integral front ridge that the managing unit 20 extends to. Alternatively, the system 10 may include an optional locking front-stop shelf attachment 50. The attachment 50 is comprised of a base 52 and may also include a vertically extending stop 54. The base 52 may have double-sided tape to attach to the shelf 12, or may be formed of or include magnets for attachment to metal shelves 12, or may attach to shelves 12 through other attachment mechanisms. The attachment 50 allows a front-stop to be added to a shelf 12 if desired. The lower divider 32 may include a matching female opening 60 for receipt of the attachment 50, if used, as shown in FIG. 9. The attachment 50 will serve two purposes. First it acts as a stop to prevent the advance of products 14 beyond the front edge of the shelf when the unit 20 is drawn forward. Secondly it acts as a locking or restraining member preventing unwanted or unintentional pulling forward of the managing units 20. The operator needs to grasp the managing unit 20 and lift the managing unit 20 so that the attachment 50 is out of engagement with the opening 60 at which point the managing unit 20 can be pulled forward.

The attachment 50 may be placed farther forward on the shelf 12 relative to the managing unit 20 essentially in front of the managing unit 20. In this construction the opening 60, if provided, may be in the front 22 formed as a cutout or “scoop out” portion of the lower edge of the front 22. The attachment 50 may take a number of forms other than the L shape shown, for example a low profile rectangular cross section protruding about ⅛″ above the surface of the shelf 12 can be effective.

FIG. 10 illustrates an optional feature for managing unit 20. For the purpose of displaying identification and price information about the products 14, an optional label holder 26 can be attached to the front 22 of managing unit 20 in a manner so as to be able to be removed. By using the label holder 26, identification and pricing information would be positioned directly in front of the products 14 associated with that managing unit 20 at all times. The traditional method is to affix the identification and price labels to the shelf edge below the products 14. Because the position of the labels on the shelf edge may not correspond directly to the position of the products 14 confusion can result where shoppers cannot easily ascertain the price and identification of the product 14.

FIG. 11 illustrates an optional interlocking channel and ridge modification. In this modification a male ridge 38 is added along the entire length of the top edge of side divider 32 and a female channel 39 is added to the entire length of the bottom edge of side divider 34. Ridge 38 is shaped to dovetail with channel 39 such that side divider 32 of one managing unit 20 can slide underneath side divider 34 of an adjacent managing unit 20 in a forward and backward direction yet movement of the respective dividers laterally apart from one another is prevented.

A further modification along the engagement arrangement shown in FIG. 11 is the use of a sliding interconnecting arrangement between the respective aligned dividers 32 and 34 such as, for example, a T-slot in one divider and a corresponding T-projection on the other divider to lock the dividers of two adjacent managing units 20 together in both lateral and vertical movement. A rod with corresponding snap fit couplings is another coupling technique that could be used for locking the dividers 32 and 34 of two adjacent managing units 20 together against lateral and vertical displacement. In these interlocking arrangements it is, of course, critical that the dividers 32 and 34 maintain complete freedom of movement in the “forward and backward” direction for managing unit 20 operation. Further, with the sliding engagement of the dividers 32 and 34 it is helpful to make at least the engaged components out of minimum-friction materials that would not detrimentally effect the operation of the respective units managing 20.

FIG. 12 illustrates an optional latch 70 for the shelf allocating and managing unit 20 that can be installed on the shelves 12 if desired. The latch 70 engages in front of the front 22 (or in front of the optional label holder 26) preventing movement of the managing unit 20 unless the latch 70 is pivoted out of the way. FIG. 12 is merely shown to illustrate one of the possible additions to the system 10 than can be added if desired. In general the managing units 20 need not have securing latches 70 or attachment 50 but these can be provided at the option of the retailer. Certain products 14 and certain shelf placements (i.e. those shelves 12 within easy reach of children) may make the latch 70, attachment 50 or similar securing device(s) more desirable for some managing units 20. The latch 70 and the attachment 50 described above can both be considered as unit arresting members in that each element prevents, to a certain extent, unintended movement of the managing unit 20.

FIG. 13 illustrates a managing unit 20 with optional magnets 100 attached to the front 22 of the managing unit 20. One or multiple magnets 100 could be attached to the underside of the front 22 or to the underside of the front portion of divider 32 for the purpose of securing the managing unit 20 in place while it is not being operated. To operate a managing unit 20 outfitted with these magnets 100 the store clerk (or customer) would have to tug the front 22 with an extra amount of force to disengage the magnets 100. The strength of the magnets 100 would be enough to keep the managing unit 20 in position in the event that it was bumped as in the case of a customer making incidental contact, but the strength would not be so much that disengaging the magnets 100 would be too difficult to allow for easy operation. The magnets 100 could also be placed in the lower portion of the backstop 40 of the managing unit 20.

FIG. 14 illustrates another modification to the present invention in which the one piece integral managing unit 20 is replaced with a two piece version. The two piece managing unit 20 of FIG. 14 has overlapping backstops 40 and fronts 22. In this manner the width of the managing unit 20 can be adjusted to fit the particular product 14. In one possible design, to connect the two pieces of managing unit 20, a downward-pointing female slot (not shown) on both the back-stop 40 and the front 22 will receive corresponding upward-pointing male inserts 92 on the back-stop 40 and front 22′. The female slots contain a series of vertical groves (not shown) spaced approximately 1/10″ apart which correspond to identically-spaced vertical ridges 93 on the male insert such that the managing unit 20 can be adjusted to accommodate products 14 of varying widths. The adjustable range would vary but might be, for purpose of illustration, 2.4″ to 3.4″ so that, at its narrowest position the managing unit 20 would accommodate a product 14 that was 2.4″ in width, and at its widest, might fit a product 3.4″ in width.

Other designs might be employed to allow the managing unit 20 to be infinitely adjusted to accommodate products 14 of different widths. Among them would be the 4-piece version of managing unit 20 (described above) where a managing unit 20 was assembled by selecting a front 22 and backstop 40 each of which corresponded to the width and height of the product 14, and selecting a divider 32 and divider 34 corresponding to the depth of the shelf 12 and attaching the four pieces together to form a managing unit 20. However designed, the adjustable managing unit 20, after it was adjusted and the component pieces fastened together securely to form a managing unit 20, would operate in the same fashion as the non-adjustable managing units 20 described above.

Another design would employ springs or other tension devices positioned in lateral orientation on the front 22 and the backstop 40, either integral to the plastic construction or in the form of attached wire springs, that would urge the two dividers 32 and 34 of one managing unit 20 to move closer to each other and would allow the dividers 32 and 34 to move apart and together across a range, for example, of one inch, to accommodate products 14 of varying widths.

FIGS. 15A and 15B illustrate further embodiments whereby two, or more, product rows, situated side-by-side, are contained within one multiple product row managing unit 20, which in the specific embodiment illustrated is a dual product row unit 20. The effect of the illustrated managing unit 20 is of two single row managing units 20 joined together at the side, along the dividers 32 and 34. The individual product rows within such a managing unit 20 move in concert with one another when the front 22 of the multi-row managing unit 20 is pulled forward. The two or more product rows within such a managing unit 20 may be separated by a middle divider 133. Each middle divider 133 may be essentially identical in form to divider 32, or to divider 34, or possibly to the combination of dividers 32 and 34. Forming the divider 133 the same as divider 32 or 34 or the combination thereof is not illustrated as this construction should be well understood from the above discussion. Alternately, as shown in FIGS. 15A and 15B, for illustrative purposes, in the case of jars, yogurt cups or other product containers where the container sides are not parallel from the extreme top of the container to the extreme bottom of the container, the divider 133 separating the two or more product rows within a multi-row managing unit 20 may be a rod or triangular member that passes, front to back, through the space presented between the products 14 when placed side-by-side. It should be apparent that two, three, four or more product rows might be situated within such a multi-row managing unit 20, with the inclusion of further middle dividers 133 as desired. Such a multi-row managing unit 20 reduces even further the labor required to front or face the merchandise in that two or more rows of product can be moved forward towards the shelf edge with a single pull. This multi row managing unit 20 is also heavier with a wider base and therefore less apt to be unintentionally tipped over or moved out of place on the shelf 12 especially when it is not filled completely with products 14. The natural disadvantage of such a system 10 using multi-row managing units 20 as compared with the single row managing units 20 is that it ties multiple product rows together and thus may not optimize the servicing of one (or more) of the rows of products 14. In other words, each row within the multi-row managing unit 20 may not have products 14 taken from each row by customers at equal rates with the result that one row of products 14 in a multi-row managing unit 20 may be mostly depleted while another row of products 14 in the multi-row managing unit 20 may be mostly full in which case using the fronting feature of the multi-row managing unit 20 may require a rebalancing of the products 14 in the multiple product rows. However, even if the multiple product 14 rows within a multi-row managing unit 20 cannot be simultaneously faced or fronted because the rows contain unequal amounts of product 14, the multi-row managing unit 20 still offers the advantage of side dividers that maintain the products 14 in proper alignment thereby facilitating stocking and preventing co-mingling of products 14 in adjacent rows.

The dual row version of managing units 20 of FIGS. 15A and 15B are also width adjustable between two width settings for each product row as shown. The backstop 40 for each row is selectively attached to one of two width adjustable positions in adjustment block 114 to provide for such adjustment. The front 22 for each row has a corresponding attachment to one of two positions in a corresponding adjustment block 114. These embodiments are designed for the use with one of two sized products, which can be listed as regular and large size for this discussion. It should be apparent that each multi-row managing unit 20 of FIGS. 15A and 15B can be orientated to display one of four distinct combinations of product rows. The four combinations include i) two regular size product rows, ii) two large size product rows, and iii and iv) two variations of a combination of one large size product row and one regular size product row. The variations for the combination of large and small product rows within the multi-row managing unit 20 is determined by on which side the large and regular size products are desired.

FIG. 15A illustrates a multi-row managing unit 20 with a divider 32 of minimal height. The divider 32 of the multi-row managing unit 20 of FIG. 15A still provides lateral support for products 14 when aligned with the divider 34 of an adjacent multi-row managing unit 20. FIG. 15B illustrates a multi-row managing unit 20 similar to multi-row managing unit 20 of FIG. 15A, with the difference being that divider 32 of the multi-row managing unit 20 of FIG. 15B is increased to a height sufficient to provide lateral support to a product 14, individually (i.e. the end multi-row managing unit 20 of a series of multi-row managing unit 20 will still have lateral support from the divider 32).

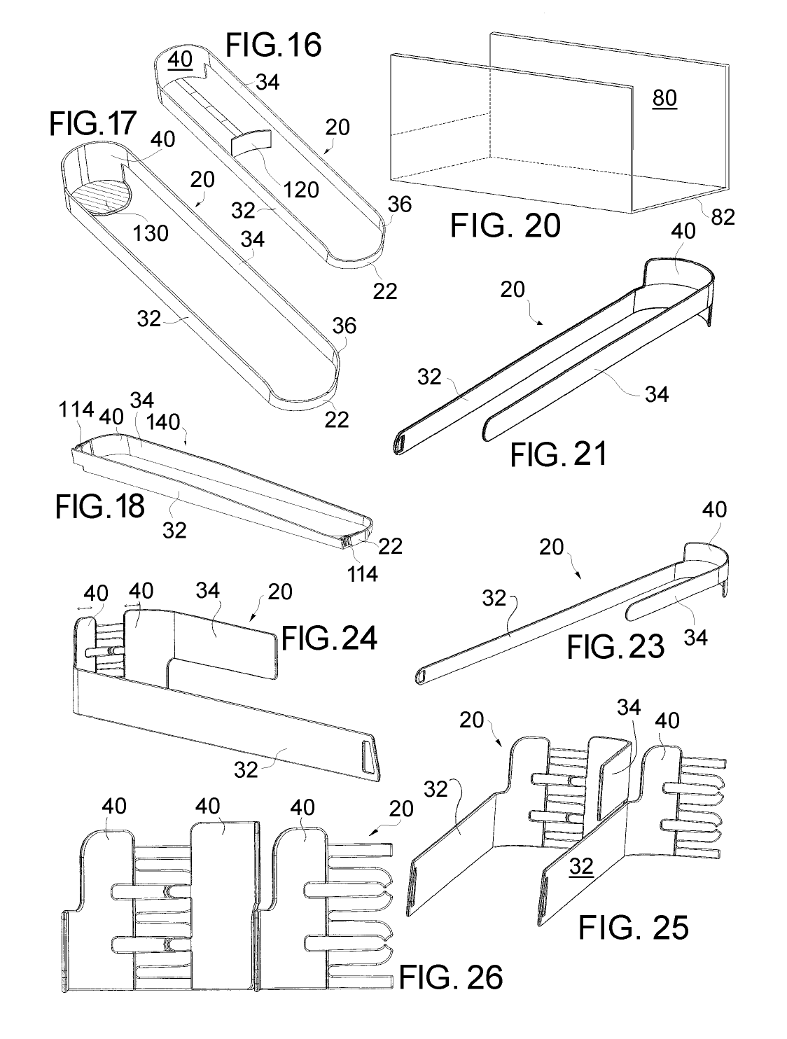

FIG. 16 illustrates an optional adjustable backstop 120 that can be removably attached to the permanent backstop 40 of a managing unit 20. This adjustable backstop 120 may be positioned at various distances forward of the permanent backstop 40 in order to shorten the effective depth of the row of products 14. This adjustable backstop 120 is useful, for example, in the case where a store prefers to stock less of a slower selling product 14 in a particular product row. The adjustment increments would be equal to the width (or depth) of one individual unit product 14. The adjustable backstop 120 can also be formed as an unattached filler block that is the shape of one or some other multiple of products (or stacked products). Forming this as an adjustable member allows the store management to vary the number of products in the “fully” stocked row of a managing unit 20 until the desired number for the given product 14 in a row is determined.

FIG. 17 illustrates a managing unit 20 with an optional removably attached platform 130 that extends forward from the base of backstop 40 on a managing unit 20. This platform 130 corresponds in size to the footprint of one individual product 14 such that one individual product 14 can rest on the platform 130 and thereby serve as a weight to help prevent the managing unit 20 from being unintentionally moved out of position. The use of the product 14 as a counterweight may be a more economical manner of adding a securing mechanism. The platform 130 still maintains the open bottom structure of the managing unit 20 as it only supports a single product 14 (or set of stacked products 14).

FIG. 18 illustrates a managing unit 20 with laterally stacking dividers that is adjustable in width to accommodate products 14 of varying widths. In such a “laterally stacking divider” managing unit 20 the dividers 32 and 34 stack side-to-side, rather than riding over and under one another when two laterally stacking divider managing units 20 are positioned side-by-side, so that two divider thicknesses are presented when two laterally stacking divider managing units 20 are positioned laterally side by side. Such a laterally stacking divider managing unit 20, which is simple in design, would be useful in those sections of a store where lateral shelf space is somewhat less scarce (or where the lateral length of the shelf 12 is such that the loss of space through adjacent dividers 32 and 34 does not accumulate to a loss of product facings in the shelf 12). One such use may be in the produce or meat areas, where the products 14 to be displayed are of varying widths.

FIG. 19 illustrates a laterally stacking divider managing unit 20 with laterally stacking dividers 32 and 34 in which two or more rows of products 14 may be positioned. In such a laterally stacking divider managing unit 20 the dividers 32 and 34, rather than riding over and under one another when two laterally stacking divider managing units 20 are positioned side-by-side, stack laterally side-to-side so that two divider thicknesses are presented when two laterally stacking divider managing units 20 are positioned side by side. Such a unit with laterally stacking dividers that can hold two or more product rows would be useful in merchandising a broad display of products nearly identical in width, and where the loss of space from the accumulation of laterally adjacent dividers 32 and 34 is not considered detrimental.

Another feature of the system 10 is the ease of product 14 resets that can be accomplished. FIG. 20 illustrates a product resetting tool 80 for use with the shelf allocation and management system 10 of the present invention. The tool 80 provides a support tray, base or sleeve into which a managing unit 20 with associated products 14 may be pulled. The sleeve of tool 80 as shown has an open end 82 that can be positioned adjacent the shelf 12 and one or more product rows within managing unit 20 advanced therein. The product row(s) is then transported to the new location, the tool 80 is placed adjacent the new shelf location and managing unit 20 is slid onto the shelf 12 moving the row(s) of products 14. Tool 80 may be wide enough so that multiple managing units 20 and multiple product rows may be moved at once. The tool 80 may be a foldable unit for easy storage. The tool 80 could be a disposable component used in the transporting of one or more units 20 as disclosed above with the shelf ready packaging units 500 of FIGS. 2A-D.

The various features of the present invention can form improved shelf management systems outside of the specific illustrated embodiments. For example the vertically aligned side dividers 32 and 34 of the present invention can yield improved shelf management systems when applied to spring biased backstops of the prior art, or in other systems where a moveable backstop is separated from the dividers or sidewalls (e.g. stationary sidewalls). Consequently further applications of the present invention include forming the shelf management system with stationary sidewalls or dividers where the stationary dividers of adjacent units are vertically aligned as with the dividers 32 and 34 illustrated in the embodiments discussed above. The construction of the vertically aligned stationary sidewalls 32 and 34 in such embodiments need not accommodate sliding moving dividers, making the construction less complex and easily accommodating interlocking of the dividers. Using the over/under divider alignment of the present invention in stationary divider systems would allow other types of shelf management systems to reduce the amount of lateral shelf space that is occupied by the system and increase the amount of usable space.

FIGS. 1A and 21-32 illustrate the cantilevered managing units 20 which essentially omit the front 22. The omission of the front 22 affords several mechanical advantages. One advantage of the cantilevered managing unit 20 is that the omission of the front 22 will prevent or minimize the shopper from unintentionally knocking the shelf tender 20 forward (or otherwise out of place) when a product 14 is pulled away and clear of the shelf 12 to be placed in the shopping cart or the like. A further advantage of the cantilevered managing unit 20 is that, in the case where the cantilevered managing unit 20 has a width-adjustable backstop, store clerks need only adjust the width of the backstop 40 rather than, in the case of the width-adjustable hoop shelf tender managing unit 20 with a front 22 and a backstop 40, store clerks being obliged to adjust both the front 22 and the backstop 40 which effectively doubles the work entailed in adjusting the managing unit 20. A further advantage of the cantilevered managing unit 20 is that a width-adjustable hoop shelf tender 20 with a front 22 and a backstop 40 may inadvertently be adjusted in a trapezoidal shape in the case where the front 22 and the backstop 40 were not positioned at equal width settings. Finally, because the cantilevered managing unit 20 has no front 22 there is no chance that the products 14 will be visually obscured when viewed from the shopping aisle.

In a further embodiment of the cantilevered managing units 20, as shown in FIGS. 23-25 each high divider 34 may be shortened to a length less than the length of low divider 32. For purpose of illustration, the low divider 32 may extend 21″ away and forward from backstop 40 while the shortened high divider 34 may extend, for example, one to fourteen inches away and forward from backstop 40. A shortened high divider 34 effectively removes the forward section of divider 34 from sight when a customer views the front of the shelf 12 and when the managing unit 20 is in the normal position with the full length of low divider 32 resting on the shelf 12. This shortened high divider is beneficial in that high divider 34, in the cantilevered unit 20 embodiment where the length of high divider 34 is equal to low divider 32, may tend to bend inwards which effectively creates an unintended narrowing of the width of the opening or mouth of the managing unit 20. This inward bending of the forward section of high divider 34 may mechanically and also visually obstruct the products 14 and may generally cause an unsightly appearance. Shortening high divider 34 in the cantilevered managing unit 20 embodiments eliminates these problems.

High divider 34 may be of a significantly shorter length than low divider 32 yet the system 10 will still provide substantive lateral support for the products 14 in the subject row because the outside of the low divider 32 of an immediately adjacent managing unit 20 forms a full-length confining and supporting boundary to the products 14 on the same side as the high divider 34 yet underneath the high divider 34 of the subject managing unit 20. The effect is that the subject product row has full lateral support on both the left and the right side.

In the embodiment where high divider 34 is shorter than low divider 32 the combined weight of low divider 32 and backstop 40 is significantly greater than the weight of high divider 34 and this weight distribution prevents the managing unit 20 from tipping in the direction of high divider 34 even though divider 34 is at no point along its length supported by contact with the shelf 12 nor is it contemplated that high divider 34 would be supported by the low divider 32 of an immediately adjacent unit. Tipping of the managing unit 20 is prevented even when the managing unit 20 contains no products 14. Even for the last cantilevered managing unit 20, on either the left or right side, within a system 10 comprised of multiple managing units 20, substantive lateral support of about ½ the total sidewall height (combined height of dividers 32 and 34) will be provided on each side of the products 14 in the subject row thereby providing effective lateral support of the products 14.

It will be appreciated by those skilled in the art that changes could be made to the embodiments described above without departing from the broad inventive concept thereof. FIGS. 24 and 25 (among others) illustrate one such modification to the present invention. In this modification the one piece integral unit managing 20 is replaced with a two piece version.

A variety of designs could be applied to allow the cantilevered managing unit 20 to be adjusted to varying widths to accommodate products 14 of different widths. Most of these designs would entail separating the cantilevered managing unit 20 at the backstop 40 into two pieces where a low divider section would be comprised of the low divider 32 together with effectively one half of the backstop 40, and a high divider section would be comprised of the high divider 34 together with effectively the other half of the backstop 40. As shown in FIGS. 24-27, a width-adjustable connection mechanism could be incorporated into the rear sections of the backstop 40 halves allowing each section to attach in such a way as to allow the cantilevered managing unit 20 to be adjusted to varying widths thereby accommodating products 14 of different widths.

As shown in FIG. 27, one embodiment of such a width-adjustable connection mechanism would employ a pair of female prongs 93 attached to one section and a corresponding male boss 94 attached to the other section where the prongs 93 slideably engage with the boss 94 allowing the boss to move to various positions along and within the prongs 93 such that high divider section and low divider section can be fixed in multiple width positions relative to one another. The distance between the prongs 93 may be slightly smaller than the thickness of the boss 94 thereby creating a tight friction slip fit so that the boss 94 would have to be urged with some force to move it from one position to another. Multiple prong-and-boss assemblies might be employed on one cantilevered managing unit 20 to attach the pair of sections. The adjustable width range would vary but might be, for purpose of illustration, 2.4″ to 3.4″ so that, at its narrowest position the cantilevered managing unit 20 would accommodate a product 14 that was 2.4″ in width, and at its widest, would fit a product 3.4″ in width. However the adjustable width mechanism were designed, the adjustable cantilevered managing unit 20, after it was adjusted and the component pieces fastened together securely to form a cantilevered managing unit 20, would operate in the same fashion as the non-adjustable cantilevered managing units 20 described above.

In a still further modification of the cantilevered managing units 20 as with the hoop managing units 20 the side divider 32 and/or side divider 34 and/or backstop 40 may include openings therein to facilitate viewing of the products 14 and/or for stylized purposes and/or to reduce the amount of plastic required for manufacture of the managing unit 20; and/or to facilitate air flow around the products 14 such as in the case where products 14 require refrigeration.

The low divider 32 being positioned on the left or right side of the managing unit 20 and the high divider 34 being positioned on either side of the managing unit 20 is unimportant provided that within an installation 10 of managing units 20, the low dividers 32 are all on the same side and the high dividers 34 are all on the opposite side in any series of managing units 20.

In the cantilevered managing units 20, the dividers 32 and 34 and backstop 40 define an open bottom, whereby at least one, and often only one, row of products 14 is positioned between the side dividers 32 and 34 on the shelf 12. Each managing unit 20 is manually movable between the front and the back of the shelf 12 via the operator grasping the forward end of the low divider 32, or grasping the optional label holder 26, and pulling forward to advance the row of products 14 from the rear towards the front of the shelf 12. When the managing unit 20 is drawn forward the backstop 40 engages the rearmost product 14 (or stack of products 14) in the row of products 14 and moves the products 14 towards the front of the shelf 12. As the rearmost product 14 is moved forward it contacts and pushes forward the next product 14 in the row and so on until all of the products 14 in the row are moved forward. The backstop 40 is pulled forward by its connection to low divider 32. The presence of high divider 34, which generally might be one half the length of low divider 32, contributes stability to backstop 40 in that high divider 34 is typically positioned laterally between products 14 in the subject product row and products 14 in the immediately adjacent rows which effectively secures divider 34 in a stable lateral position. When the managing unit 20 is drawn forward high divider 34 will usually be secured laterally between products 14, and because high divider 34 is attached to backstop 40, and because high divider 34 generally is confined laterally thereby adding stability to backstop 40, backstop 40 is thereby stabilized and prevented from contorting. The result is that when the cantilevered managing unit 20 is pulled forward backstop 40 remains in correct position (instead of bending backward) effectively cupping the products 14 and pushing them forward. With the products 14 advanced towards the front of the shelf 12 the managing unit 20 is slid back to the starting position with the forward section of low divider 32 positioned approximately at the front edge of the shelf 12.

In a further embodiment, as shown in FIGS. 33 and 34, a hoop managing unit 20 may be comprised of a backstop 40 a low divider 32 and high divider 34 of equal lengths and a front 22 that connects to and joins together the forward ends of both low divider 32 and high divider 34. In this embodiment the low divider 32 and high divider 34 may not in vertical alignment and yet a single divider thickness is presented between two immediately adjacent product rows owing to the fact that the containers of products 14 may be trapezoidal in shape (e.g. yogurt cups) where the product containers are significantly wider at the top than they are at the base. When trapezoidal products of this sort are positioned side-by-side a wide gap is presented and the low divider 32, provided it is narrower than is the gap, may occupy a variety of lateral positions inside this gap including a position directly under the high divider 34 or a position to one side or the other of the position of high divider 34. Even in the case where the low divider 32 is not vertically aligned with the high divider 34 a single divider thickness is presented between immediately adjacent product rows. This embodiment allows for both the low divider 32 and high divider 34 to contact, along their full lengths, the shelf 12.

In a further embodiment a slideably attached tray or base 80 could be attached to the unit 20 where the base 80 is generally as wide as the products 14 and as long as the dividers 32 and 34 and thick enough to provide substantial rigidity, perhaps ⅛″ thick. The base 80 could be fashioned with channels running down the full length of the left and right edges where these channels would receive corresponding male projections that would extend along the length of the bottom of the two dividers 32 and 34. The managing unit 20 could be drawn forward while the base 80 was held in stationary position which would allow the products 14 to be brought forward to the front edge of the shelf 12. The managing unit 20 would then be returned to the starting position at which point the entire managing unit 20 including the base 80 could be lifted off of the shelf 12 exposing the rear portion of the managing unit 20 thereby allowing new products 14 to be stocked behind the existing products thereby allowing for proper rotation of the products 14. The front 22 is of low profile, preferably one inch high or less, so that the front 22 does not block access for shoppers to the front of the product row and so the front 22 does not create a visual obstruction of the products 14. The front 22 may be modified to receive an identification label for the products 14 that are associated with the managing unit 20.

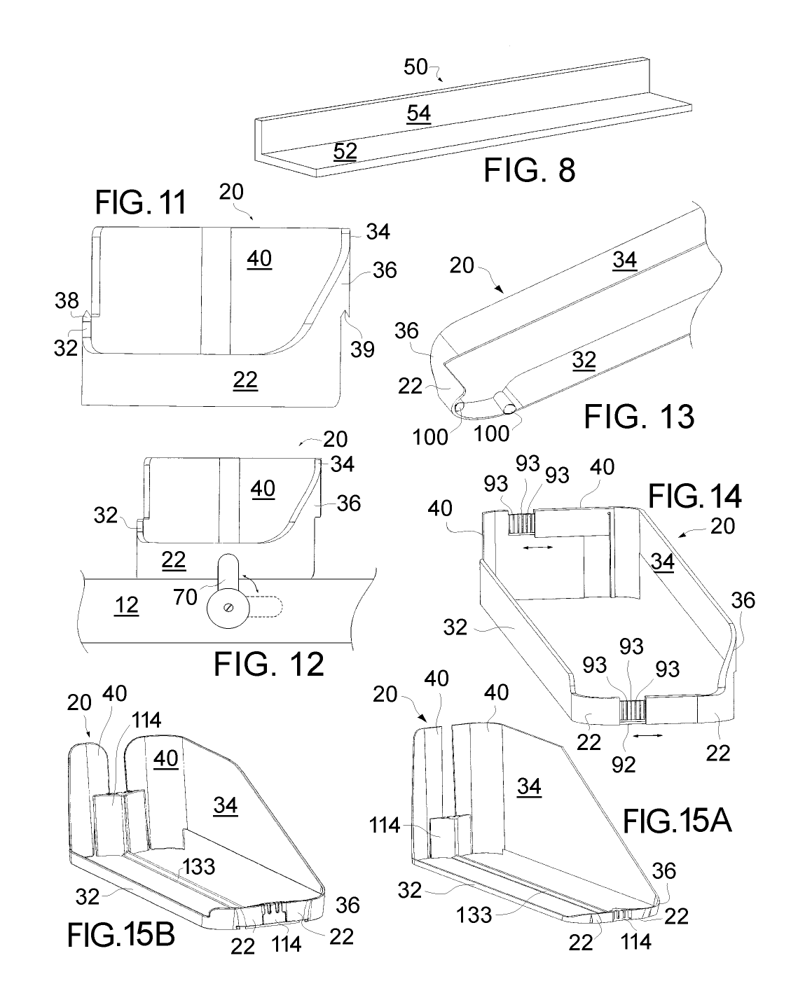

As shown in FIGS. 31 and 32, the system 10 may be used with effectively any shelf 12 with the length of the divider 32 being associated with the shelf depth as noted above. The shelf 12 may have an integral front ridge that the unit 20 extends to. Alternatively, the system 10 may include an optional locking front-stop shelf attachment 50 substantially as described above in connection with FIGS. 8-9. FIG. 30 illustrates an optional feature for cantilevered managing unit 20. For the purpose of displaying identification and price information about the products 14, an optional label holder 26 can be removably attached to the front of low divider 32 of cantilevered managing unit 20 similar to managing unit 20 of FIG. 10 described above.

FIG. 29 illustrates an optional feature for the cantilevered managing unit 20. A slideably attached base or tray 80 could be added to the managing unit 20 where the base 80 is generally as wide as the products 14 and as long as the low divider 32 and thick enough to provide substantial rigidity, perhaps ⅛″ thick. The base 80 could be fashioned with a channel running down the full length of the left or the right edge where this channel would receive a corresponding male projection that would extend along the length of the bottom of the low divider 32. The managing unit 20 could be drawn forward while the base 80 was held in stationary position which would allow the products 14 to be brought forward to the front edge of the shelf 12. The unit 20 would then be returned to the starting position at which point the entire managing unit 20 including the base 80 could be lifted off the shelf 12 exposing the rear portion of the managing unit 20 thereby allowing new products 14 to be stocked behind the existing products thereby allowing for proper rotation of the products 14.

Other designs might be employed to allow the managing unit 20 to be infinitely adjusted to accommodate products 14 of different widths. Among them would be a 3-piece version of managing unit 20 where a managing unit 20 was assembled by selecting a backstop 40 which corresponded to the width and height of the product 14, and selecting a low divider 32 and high divider 34 corresponding to the depth of the shelf 12 and attaching the three pieces together to form a managing unit 20. However designed, the adjustable managing unit 20, after it was adjusted and the component pieces fastened together securely to form a managing unit 20, would operate in the same fashion as the non-adjustable managing units 20 described above. A further alternative design is to have a geared adjustment (i.e. a gear wheel) meshed or engaged between the two associated backstop portions to allow for discrete adjustment that can be easily adjusted and that will easily and firmly hold the adjusted position.

FIG. 28 illustrates an optional adjustable backstop 140 that can be removably attached to the permanent backstop 40 of a managing unit 20. This adjustable backstop 140 may be positioned at various distances forward of the permanent backstop 40 in order to shorten the effective depth of the row. As shown in FIGS. 21 and 23 in a further embodiment the managing unit 20 would incorporate a backstop 40 that was, along the lateral dimension, curved in a concave fashion so as to be sympathetic to and to receive the generally round shape of the products 14. This concave curve would allow for more thorough contact of the backstop 40 with the products 14 when the managing unit 20 is drawn forward with the effect that backstop 40 is less apt to bend backwards in response to the weight/inertia of the products 14.

FIG. 35 shows a further embodiment where the managing unit 20 may be comprised of a backstop with both a low and a high side divider extending forward to a front where, when two units are immediately adjacent to one another, the low side divider of one unit is in vertical alignment with the high side divider of the immediately adjacent managing unit 20, and further where both the front and the rear of the unit incorporate width adjusting mechanisms where the front 22 includes a front width adjusting mechanism in the form of a width-adjustable disc 85 that is formed as a disc designed to rest flat on the shelf 12 so that the front-most product in the product row associated with the unit rests directly on top of the width-adjustable disc 85 and wherein the front width-adjustable disc 85 is of a sufficiently low vertical profile that the front-most product 14, when resting on top of the front width-adjustable disc 85, is not raised to a vertical height that would appear to be substantially different from the vertical heights of the other products 14 in the associated product row. The width-adjustable disc 85 is comprised of a left-side piece and a right-side piece where each piece has two tongues or tabs, each with either female detents or male ridges, where the tongues of the left-side piece interlace with the tongues of the right side piece in such a way as to allow the front of the managing unit 20 to be positioned to accommodate products 14 of various widths. The two tongues of the left-side piece are mirror opposites of the two tongues of the right-side piece thereby allowing the four tongues to interlace with one another. In an alternate embodiment the front 22 may be of fixed width and orientated in a manner similar to disc 85 to present an extremely low profile and further have ramp shaped both leading and trailing edges.

FIG. 36 illustrates an embodiment of managing unit 20 that includes a removable backstop extension 41 attachable to the back stop 40 with clips connecting to bosses provided on the back stop 40. This allows the height of the backstop 40 to be extended so that a wider selection of products 14 might be accommodated.

It is understood, therefore, that this invention is not limited to the particular embodiments disclosed, but it is intended to cover modifications that are within the spirit and scope of the invention, as defined by the appended claims and equivalents thereto.

What is claimed is:

1. A manual open bottom shelf allocation and management system for allocating shelf space among rows of products and for moving the rows of products toward the front of the shelf, the system comprises:
a plurality of adjacent shelf allocating and managing units, each unit moveable relative to the shelf and associated with at least one row of products, wherein each unit includes
a backstop adapted to be at the rear of the at least one row of products near a rear edge of the shelf,
a pair of side dividers providing lateral support to at least one row of products and extending away from the backstop defining an open bottom adjacent the shelf, wherein the at least one row of products associated with the unit may be positioned on the shelf between the side dividers, and wherein the backstop and pair of side dividers of each unit are manually movable together as an integral unit in a direction extending between the front and the back of the shelf substantially perpendicular to the lateral length of the shelf whereby each unit is adapted to advance the at least one row of products associated with the unit toward the front of the shelf, and wherein one side divider of each of two adjacent units are in vertical alignment with one another such that a distance equal to the thickness of only one side divider is between the product rows adjacent each vertically aligned side divider.

2. The manual open bottom shelf allocation and management system according to claim 1 wherein each unit includes a front extending between the side dividers, wherein the pair of side dividers, the backstop and the front form a hoop surrounding the at least one row of products associated with the unit.

3. The manual open bottom shelf allocation and management system according to claim 1 further including side dividers of different lengths where one side divider may be substantially longer than the other.

4. The manual open bottom shelf allocation and management system according to claim 3 further including a width adjusting mechanism allowing the spacing between the pair of side dividers to be adjusted to accommodate the width of the products, whereby the width adjustment mechanism will secure the side dividers in a plurality of selected relative positions.

5. The manual open bottom shelf allocation and management system according to claim 1 further including a product supporting base that is slideably attached to the bottom of at least one side divider.

6. The manual open bottom shelf allocation and management system according to claim 1 further including a product identifying label holder that is removably attached to the front of at least one unit.

7. The manual open bottom shelf allocation and management system according to claim 1 further including a unit arresting member associated with at least one unit which can prevent the associated unit from being moved forward, wherein the unit arresting member includes a stop, wherein the stop is coupled to the shelf whereby the unit is prevented from being moved forward to advance the product until the unit is lifted to a position to clear the stop.

8. The manual open bottom shelf allocation and management system according to claim 1 further including a backstop having adjustable height.

9. The manual open bottom shelf allocation and management system according to claim 1 further including a width adjusting mechanism allowing the spacing between the pair of side dividers to be adjusted to accommodate the width of the products, whereby the width adjustment mechanism will secure the side dividers in a plurality of selected relative positions.

10. The manual open bottom shelf allocation and management system according to claim 1 further including a backstop contoured in a concave fashion when viewed from the front of the unit.

11. A shelf ready packaging unit comprising:
At least one row of products;
A manual open bottom shelf allocating and managing unit associated with the at least one row of products for moving the rows of products toward the front of the shelf after the row of products has been placed upon a shelf; and
Packaging material coupling the shelf allocating and managing unit and the at least one row of products together at least for shipping and stocking.

12. The shelf ready packaging unit according to claim 11 wherein the shelf allocating and managing unit includes a backstop adapted to be at the rear of the at least one row of products near a rear edge of the shelf, and a pair of side dividers extending away from the backstop defining the open bottom adjacent the shelf.

13. The shelf ready packaging unit according to claim 12 wherein the at least one row of products associated with the unit may be positioned on the shelf between the side dividers, and wherein the backstop and pair of side dividers of each unit are manually movable together as an integral unit in a direction extending between the front and the back of the shelf substantially perpendicular to the lateral length of the shelf whereby each unit is adapted to advance the at least one row of products associated with the unit toward the front of the shelf.

14. The shelf ready packaging unit according to claim 13 wherein one side divider of each of two adjacent units are in vertical alignment with one another such that a distance equal to the thickness of only one side divider is between the product rows adjacent each vertically aligned side divider.

15. The shelf ready packaging unit according to claim 12 wherein the packaging material includes a supporting tray and surrounding plastic wrap.

16. The shelf ready packaging unit according to claim 12 wherein open product spaces within the shelf allocation and management unit are provided to accommodate products remaining on the shelf from earlier stocking for product rotation during shelving.

17. A manual open bottom shelf allocation and management system for allocating shelf space among rows of products and for moving the rows of products toward the front of the shelf, the system comprises:
a plurality of adjacent shelf allocating and managing units, each unit associated with at least one row of products, wherein each unit includes
a backstop adapted to be at the rear of the at least one row of products near a rear edge of the shelf,
a pair of side dividers extending away from the backstop defining an open bottom adjacent the shelf, wherein the at least one row of products associated with the unit may be positioned on the shelf immediately adjacent the side dividers, and wherein the side dividers and backstop of each unit is manually movable as an integrated unit in a direction extending between the front and the back of the shelf substantially perpendicular to the lateral length of the shelf whereby each unit is adapted to advance the at least one row of products associated with the unit toward the front of the shelf, and wherein the side dividers provides for substantive lateral support for the products adjacent the divider when a side divider is coupled with a side divider of an adjacent unit.

18. The manual open bottom shelf allocation and management system according to claim 17 further including a width adjusting mechanism allowing the spacing between the side divider and the side edge of the backstop opposite the side divider to be adjusted to accommodate products of different widths, wherein the width adjustment mechanism will secure the backstop in a plurality of selected relative positions.

19. The manual open bottom shelf allocation and management system according to claim 17 wherein adjacent side dividers of each of two adjacent units are not in vertical alignment with one another and wherein a distance equal to the thickness of only one side divider is between adjacent product rows of adjacent units.

20. The manual open bottom shelf allocation and management system according to claim 19 further including a product supporting base that is attached to the bottom of at least one side divider.
